(19) United States
(12) Patent Application Publication
(10) Pub. No.: US 2011/0199687 A1
(43) Pub. Date: Aug. 18, 2011

(54) PROCESS FOR THE MANUFACTURE OF FLAT OPTICAL ELEMENTS AND ELEMENTS THUS OBTAINED

(75) Inventors: Julien Sellier, Paris (FR); Arnaud Huignard, Compiegne (FR); Xavier Brajer, Cormeilles en Parisis (FR)

(73) Assignee: SAINT-GOBAIN GLASS FRANCE, Courbevoie (FR)

(21) Appl. No.: 12/934,764

(22) PCT Filed: Mar. 25, 2009
(86) PCT No.: PCT/FR2009/050514

§ 371 Date: Oct. 15, 2010

(30) Foreign Application Priority Data
Mar. 27, 2008 (FR) 0851964

(51) Int. Cl. G02B 3/00; C03C 21/00

(52) U.S. Cl. 359/652; 65/30.13

(57) ABSTRACT

The process according to the invention is based on the simultaneous ion exchange of two ions having an almost identical mobility with the ions of a glass substrate, at least one of the aforementioned two ions being used in the form of an enamel.

According to a first embodiment, the process comprising the steps that consist in:
a) depositing, at the surface of a glass substrate that contains a first ion, an enamel composition containing a second ion chosen from Ag, Tl, Ba or Cu ions, or precursors thereof, in the form of a pattern or an array of patterns;
b) bringing the substrate to a temperature sufficient to fire the enamel;
c) immersing the substrate into a molten salt that comprises a third ion having a mobility almost equal to that of the second ion;
d) applying an electric field through the immersed substrate so that the second ions originating from the enamel and the third ions originating from the molten salt simultaneously replace the first ions in the substrate;
e) withdrawing the substrate from the molten salt; and
f) removing the enamel.

The present invention relates to the field of flat optical elements for the production of imaging devices, in particular flat lenses that have a refractive index gradient, especially a cylindrical refractive index gradient.

It relates more precisely to a process for manufacturing such flat optical elements by ion exchange in an electric field.

For several years there has been a growing interest in “compact” optical devices that incorporate, in particular, miniature cameras, such as cell phones, automobile navigation systems, equipment for medical diagnosis, in particular endoscopes, etc. The ever increasing miniaturization of these devices requires the use of optical elements, especially lenses, which reconcile very small dimensions with excellent optical quality.

Lenses having a refractive index gradient (GRadient INdex lenses or “GRIN lenses”) have been the subject of many developments, the purpose of which is in particular to be able to control the shape and the variation of the refractive index. Such lenses may be made of glass, of quartz, of ceramic or of an organic polymer.

Glass GRIN lenses may be obtained in a greater or lesser number from a single substrate by a process that combines photolithography (for producing a mask at the surface of the glass having the shape of the desired pattern(s)) and ion exchange (for obtaining the refractive index gradient). Ion exchange is a well-known technique based on the capacity that certain ions of different polarizabilities have, in particular the alkali metal ions, to be able to be exchanged with one another, or with other ions such as Ag, Tl, Cs and Cu, and to thus form an ionic pattern. The ion exchange is carried out by treating the glass in a bath of molten salts of said ions at a high temperature, generally between 200 and 550° C., for a sufficient duration to obtain the desired level of exchange.

Described in U.S. Pat. No. 4,952,037 and US 2003/0161048, is a process for manufacturing patterns in a glass substrate by ion exchange with Ag ions. The patterns have a hemispherical (GRIN lens) or semi-cylindrical shape.

U.S. Pat. No. 6,066,273 describes the manufacture of patterns having an axial refractive index gradient from a glass substrate of any shape by ion exchange with Ag ions. The distribution of the refractive index gradient in the substrate follows an almost linear curve.

In US 2001/0003724, the gradient-index patterns are formed from a glass rod by exchange with Ag ions. These patterns have a distribution along the radial direction of said rod.

In US 2006/0148635, it is proposed to form a glass bar containing thallium in order to produce lenses by ion exchange with alkali metal ions, especially potassium ions. The refractive index distribution in the bar is parabolic.

With the processes for obtaining GRIN lenses that have just been described, the profile of the refractive index depends mainly on the exchange duration, on the ion exchanged, on the composition and on the shape of the substrate. The modification of the hemispherical or semi-cylindrical profile obtained under these conditions inevitably goes through operations of cutting and polishing the substrate. These operations require the use of particularly expensive precision tools.

Furthermore, it is known that the application of an electric field during the ion exchange makes it possible to accelerate the exchange rate of the ions and to better control the trajectory of these ions in the substrate, especially with a view to limiting their lateral migration and/or diffusion. This operating method is used for example for producing waveguides, the boundaries of which are sharp and straight, but the depth of which does not generally exceed a few micrometers. The waveguides are then subjected to a second exchange, in an electric field, with an ion having a mobility lower than that of the ion used during the first ion exchange in order to bury them in the substrate. Such processes are described in U.S. Pat. No. 3,880,630 and EP 0 380 468.

One object of the present invention is to provide a process for the manufacture of flat optical elements, in particular of flat, especially cylindrical, GRIN lenses in a glass substrate, which makes it possible to obtain a refractive index that varies radially and in a substantially uniform manner in the thickness of the substrate.

Another object of the invention is to provide a process that makes it possible to provide flat optical elements that have a large variation of the refractive index (Δn), in particular of at least 0.01, over a large exchange depth, in particular of at least 50 μm, preferably of at least 100 μm and advantageously at least 200 μm.

Another object of the invention is to provide a process that makes it possible to vary the profile of the refractive index to a large extent, and also to produce optical elements, especially GRIN lenses, capable of making light diverge or converge.

The process according to the invention is based on the simultaneous ion exchange of two ions having an almost identical mobility with the ions of a glass substrate, at least one of the aforementioned two ions being used in the form of an enamel.

According to a first embodiment, the flat optical elements are obtained according to a process comprising the steps that consist in:

a) depositing, at the surface of a glass substrate that contains a first ion, an enamel composition containing a second ion chosen from Ag, Tl, Ba or Cu ions, or precursors thereof, in the form of a pattern or an array of patterns;

b) bringing the substrate to a temperature sufficient to fire the enamel;

c) immersing the substrate into a molten salt that comprises a third ion having a mobility almost equal to that of the second ion;

d) applying an electric field through the immersed substrate so that the second ions originating from the enamel and the third ions originating from the molten salt simultaneously replace the first ions in the substrate;

e) withdrawing the substrate from the molten salt; and

f) removing the enamel.

In the present invention, the expression “enamel composition” is understood to mean a composition comprising a glass fit generally in the form of a powder and of a medium or “vehicle” that ensures a good suspension of the particles of the frit. During the firing, the vehicle is consumed and the glass frit is converted into a glassy matrix that forms the final enamel.

Similarly, the expression “glass substrate” is understood to mean a substrate made of glass or of glass-ceramic. The substrate is generally a sheet of glass having a variable thickness, generally less than 10 mm and preferably between 300 μm and 4 mm.

In this embodiment, the enamel composition comprises at least one glass frit and at least one medium, and it also contains the second ion.

The glass frit has a melting point greater than or equal to 400° C., preferably greater than or equal to 500° C. The glass frit must be able to be converted into a glassy matrix at the firing temperature, which temperature must not exceed the softening point of the substrate in order to prevent it from being deformed.

The glass frit may be chosen from the frits composed of any type of glass, advantageously a glass that contains bismuth, boron or zinc. Glass frits that contain lead should be avoided for reasons of toxicity and of recycling of the glass. Particularly advantageously, the frit is composed of a glass that has a composition close to that of the substrate, which makes it possible to avoid the appearance of stresses in the final substrate.

The second ion is present in the enamel composition in the form of the corresponding oxide of Ag, Tl, Ba or Cu, or of a metal.

The Ag, Tl, Ba or Cu oxide is contained in the glass frit; it is one of the constituents of the latter. The glass frit may be obtained by adding the second ion in the nitrate or chloride form, or in the oxide form to the vitrifiable batch materials, which are then melted to give a glass, and the molten glass is treated in a conventional manner in order to form a frit. The weight content of the second ion in the frit is at least equal to 5%, preferably at least equal to 20%.

When the second ion is a metal, it is present in the enamel composition in the form of particles, preferably having an average size that varies from 1 to 10 μm.

The amount of second ion represents at least 20%, preferably at least 50%, by weight of the enamel composition.

The medium has the role of ensuring a good suspension of the frit particles, and where appropriate of the second ion, and bonding to the substrate until the firing step b). It must be able to be consumed during the firing of the enamel.

Conventionally, the medium is chosen from solvents, diluents, oils, especially plant oils, such as castor oil, pine oil and mixtures of terpineols, resins such as acrylic resins, oil fractions and film-forming materials, for example cellulose materials. The medium generally represents 15 to 40% by weight of the enamel composition.

The enamel composition may be deposited at the surface of the substrate by any known means, for example by screen printing, sputtering, inkjet printing or by means of dispensing system(s), especially of the syringe(s) type. This means should be chosen as a function of the shape, dimensions and number of patterns to be made.

The shape of the pattern may vary to a very large extent, and may be for example any geometric shape, advantageously a circle.

One particularly advantageous variant according to the first embodiment of the process according to the invention lies in the possibility of forming patterns for which the amount of second ion may vary within each pattern. For example, a circular pattern may be composed of concentric secondary patterns, each concentric secondary pattern being composed of an enamel composition containing an amount of second ion different from the adjacent secondary pattern. This operating method makes it possible to vary the refractive index profile to a large extent and to adjust it precisely, which is particularly advantageous for the production of both convergent and divergent GRIN lenses.

Optionally, the substrate may undergo a heat treatment for the purpose of temporarily fixing the enamel composition to allow easier handling without risk of damaging the patterns. The treatment temperature must not exceed the melting point of the frit and preferably remains at least 100° C. below said melting point of the frit.

Step b) of firing the enamel is carried out at a temperature above the melting point of the glass frit and below the softening point of the substrate. The duration must be long enough so that the glass frit forms a glassy matrix. By way of illustration for a substrate made of soda-lime-silica glass, the firing is conducted at a temperature that does not exceed 700° C., preferably that varies from 600 to 680° C. for less than 60 minutes, preferably 10 to 30 minutes.

As a general rule, it is desirable for the enamel to have a porosity that is as low as possible (or a compactness that is as high as possible) in order to obtain the greatest degree of ion exchange.

The third ion contained in the molten salt of step c) must have a mobility almost equal to that of the second ion. Preferably, the third ion is chosen from the Na, K and Li alkali metal ions, advantageously Na, and the Ca and Sr alkaline-earth metal ions, advantageously Ca.

Preferably, the third ion is identical to the first ion of the substrate, which makes it possible to minimize the appearance of stresses in the glass and to prevent the deformation of the electric fields lines in the following step d).

The molten salt is preferably held at a temperature at least 10° C., preferably at least 20° C., above the melting point of the salt.

The value of the electric field applied in step d) depends on the nature of the second and third ions, and equally on the composition of the substrate. In general, the electric field is chosen so as to obtain a migration rate of these ions in the substrate that varies from 0.01 to 1 μm/min.

The removal of the enamel in step e) may be carried out by any known means, for example by polishing or by a treatment with an acid, in particular nitric acid when the second ion is Ag.

The process according to the invention may comprise a supplementary step g) that aims to reduce the thickness of the substrate after the ion exchange treatment. This step may be carried out before or after step f) of removing the enamel.

The reduction of the thickness of the substrate is carried out in particular when the ion exchange by the second and third ions does not take place over the entire thickness of the substrate. Indeed, it may prove advantageous to carry out the ion exchange over a greater or lesser depth, in particular in order to prevent the risks of rupture of the substrate resulting from the appearance of significant mechanical stresses generated by the migration of said ions. In this case, it is necessary to thin the substrate via the face not exchanged by said ions until the refractive index is substantially uniform over the remaining thickness, which makes it possible, in particular, for the subsequent step of radial diffusion of the second ions described below in step h) to be able to be carried out correctly, avoiding any possibility of axial migration of these ions.

The treatment for thinning the substrate may be mechanical, for example polishing, or chemical, in particular with hydrofluoric acid.

The process according to the invention may comprise a supplementary step h) that consists in subjecting the substrate to a temperature sufficient to enable a radial diffusion of the third ions. This operating method makes it possible to produce flat GRIN lenses.

In the case of a glass substrate, the heat treatment is generally carried out at a temperature between 300 and 700° C., preferably between 400 and 600° C., for a duration between a few hours and a few days depending on the nature of the substrate.

Step h) may be carried out before or after step f) of removing the enamel.

When the optional steps g) and h) are present, the diffusion of the ions is necessarily carried out after the substrate has been thinned.

According to one advantageous variant, the process comprises a supplementary step that consists in applying a protective layer to the enamel obtained at the end of step b). The role of the protective layer is to prevent the third ions from migrating into the enamel and disrupting, via a “dilution” effect, the exchange of the first ions contained in the substrate by the second ions of the enamel.

The protective layer may be, for example, a layer of Ni/Cr, of Ti, of Si or of Ag. It is preferably deposited on the enamel by magnetron sputtering. The thickness of the layer may vary from 100 nm to 1 μm, and preferably is around 200 nm.

According to a second embodiment, the flat optical elements are obtained according to a process comprising the steps consisting in:

a) masking the surface of a glass substrate that contains a first ion with an enamel composition containing a second ion consisting of Na, K or Li alkali metal ions, or Ca or Sr alkaline-earth metal ions;

b) bringing the substrate to a temperature sufficient to fire the enamel;

c) bringing the substrate into contact with a liquid or solid source containing a third ion consisting of Ag, Tl, Ba or Cu ions;

d) applying an electric field through the substrate so that the second ions originating from the first enamel composition and the third ions originating from the liquid or solid source simultaneously replace the first ions in the substrate; and

e) removing the enamel.

The enamel composition from step a) comprises a glass frit that contains a second ion consisting of Na, K or Li alkali metal ions, or Ca or Sr alkaline-earth metal ions, and a medium.

Preferably, the frit is composed of a glass that contains at least 15% by weight, preferably at least 20% of said second ion, preferably Na or Ca.

Advantageously, the frit also contains at least 10% by weight of zinc and at least 10% by weight of boron.

The medium may be chosen from the media cited previously in the first embodiment.

The enamel composition is applied to the surface of the substrate in a given pattern that masks the parts that must not undergo the ion exchange by the third ion and makes openings that have a shape corresponding to the final optical elements.

Step b) of firing the enamel may be carried out under the same conditions as step b) of the process according to the first embodiment.

According to a first variant of step c), the source containing the third ion is liquid. This source is composed of a molten salt of the third ion, for example a nitrate, a sulfate or a chloride, and preferably a nitrate.

According to a second variant of step c), the source containing the third ion is solid.

The source may be a deposition of the corresponding metal, for example carried out by magnetron sputtering or electrodeposition, or an enamel composition having the same characteristics as the enamel composition described previously in step a) of the first embodiment. It is preferred to use the third ion in the form of an enamel composition. In this case, a heat treatment is necessary for firing the enamel, this treatment possibly being carried out under the conditions described previously for the first embodiment.

The source may also be a deposition of particles of the corresponding metal (Ag, Tl, Ba, Cu) and/or of particles of a precursor of the third ion, for example in the form of an oxide, a chloride or a nitrate. The deposition is generally obtained by the application to the substrate of a composition comprising said particles and a medium such as defined in step a) of the first embodiment, and of a heat treatment at a temperature of around 300° C. for the purpose of removing the medium.

Steps d) and e) are carried out under the same conditions as respective steps d) and f) of the first embodiment.

The process according to the second embodiment may comprise a supplementary step f) that aims to reduce the thickness of the substrate after the ion exchange treatment, which is identical to step g) described for the first embodiment. This step is carried out after step d), and before or after step e).

The process according to the second embodiment may also comprise a step g) that consists in subjecting the substrate to a temperature sufficient to enable a radial diffusion of the third ions, which is identical to step h) described for the first embodiment. This step is carried out after step d) or f).

It goes without saying that the process according to this second embodiment can only be carried out correctly if the mobility of the second ions is almost equal to that of the third ions.

One advantageous variant according to the second embodiment of the process according to the invention lies in the possibility of incorporating a third ion into the enamel constituting the mask of the step so as to be able to adjust the refractive index profile of the optical elements.

The incorporation of the third ion takes place by means of an enamel composition that is applied separately to that which constitutes the mask in the peripheral zone of the openings in said mask. Preferably, the opening in the mask is circular and the enamel containing the third ion is applied in the form of a concentric pattern, said pattern and said mask possibly or possibly not being contiguous. In this way it is possible to form convergent or divergent GRIN lenses.

As indicated previously, the glass substrate that can be used in the context of the process of the invention may be made of glass or of glass-ceramic.

The glass substrate may be obtained by the “float” process from a glass in the molten state floated on a bath of molten metal, especially tin. The glass may be a conventional soda-lime-silica or lime-silica glass, a borosilicate glass or an E-type glass that may or may not contain Ba.

Preferably, when the ions to be exchanged are Ag ions, the substrate is composed of a glass that has a weak ability to undergo yellowing, that is to say that is not or is weakly yellow-colored after the ion exchange treatment. By way of example, mention may be made of the glasses corresponding to the following composition, expressed as percentages by weight:

Composition 1

| | |
|---|---|
| SiO₂ | 67.0-73.0%, preferably 70.0-72.0%; |
| Al₂O₃ | 0-3.0%, preferably 0.4-2.0%; |
| CaO | 7.0-13.0%, preferably 8.0-11.0%; |
| MgO | 0-6.0%, preferably 3.0-5.0%; |
| Na₂O | 12.0-16.0%, preferably 13.0-15.0%; |
| K₂O | 0-4.0%; |
| TiO₂ | 0-0.1%; |
| Total iron (expressed as Fe₂O₃) | 0-0.03%, preferably 0.005-0.01%; |
| Redox (FeO/total iron) | 0.02-0.4, preferably 0.02-0.2; |
| Sb₂O₃ | 0-0.3%; |
| CeO₂ | 0-1.5%; and |
| SO₃ | 0-0.8%, preferably 0.2-0.6%. |

Composition 2

| | |
|---|---|
| SiO₂ | 60.0-80.0%, preferably 66.0-80.0%; |
| Al₂O₃ | 0-8%, preferably 1.5-8%; |
| B₂O₃ | 6.0-16.0%, preferably 10.0-14.0%; |
| CaO | 0-2.0%, preferably less than 0.5%; |
| ZnO | 0-1%; |
| BaO | 0-4%; |
| MgO | 0-2.0%, preferably less than 0.5%; |
| Na₂O | 6.0-10.0%, preferably 6.0-8.0%; |
| K₂O | 0-4.0%, preferably 0-2.0%; |
| TiO₂ | 0-2.0%, preferably less than 0.5%; |
| Total iron (expressed as Fe₂O₃) | 0-0.1%, preferably 0-0.08%; |
| Redox (FeO/total iron) | 0.02-0.6, preferably 0.02-0.4; |
| MnO | 0-0.1%, preferably 0-0.05%; and |
| SO₃ | less than 0.2%. |

The glass-ceramic substrate that can be used in the process according to the invention may have the following composition, expressed as percentages by weight:

| | |
|---|---|
| SiO₂ | 60.0-72.0%, preferably 64.0-70.0%; |
| Al₂O₃ | 15.0-25.0%, preferably 18.0-21.0%; |
| CaO | 0-5%, preferably 0-1.0%; |
| MgO | 0-5%, preferably 1.0-3.0%; |
| ZnO | 0-5%, preferably 1.0-3.0%; |
| BaO | 0-5%, preferably 0-1.0%; |
| TiO₂ | 0-5%, preferably 0-3.0%; |
| ZrO₂ | 0-5%, preferably 1.0-4.0%; |
| Li₂O | 2.0-8.0%, preferably 3.0-5.0%; |
| Na₂O | 0-5%, preferably 0-3.0%; |
| K₂O | 0-5%, preferably 0-3.0%; |
| Total iron (expressed as Fe₂O₃) | 0-0.1%, preferably 0-0.08%; |
| Redox | 0.02-0.6, preferably 0.02-0.4; |
| As₂O₃ | 0-1.0%; |
| ZnS | 0-1.0%; |
| SnO₂ | 0-1.0%; and |
| impurities | <0.5%. |
| (HfO₂, Cr₂O₃ and/or P₂O₃) | |

The detailed description below makes it possible to better appreciate the invention and the advantages that it presents. This description is illustrated by the following figures, which represent:

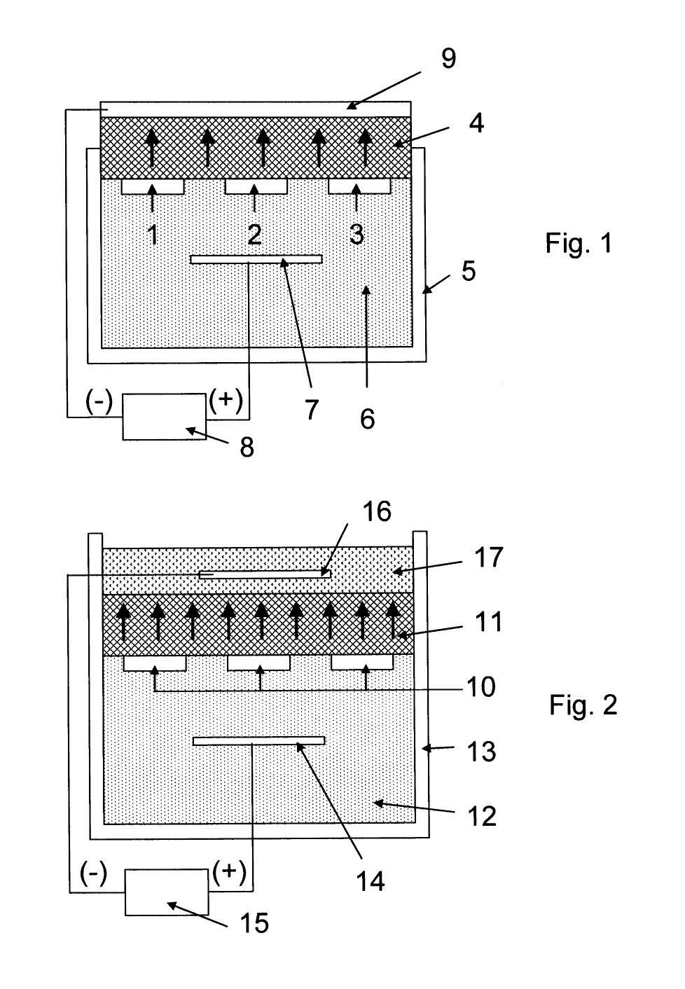

FIG. 1: a cross-sectional view of the substrate during the ion exchange in an electric field according to the first embodiment;

FIG. 2: a cross-sectional view of the substrate during the ion exchange in an electric field according to the second embodiment; and

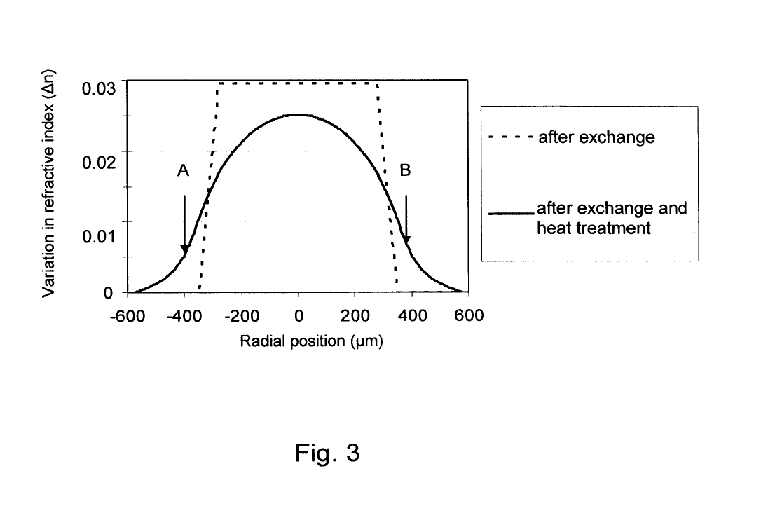

FIG. 3: un diagram showing the refractive index profile in the GRIN lens obtained according to the first embodiment of the invention. These figures are given by way of example and can in no way constitute a limitation of the invention.

In FIG. 1, patterns 1, 2, 3 are deposited at the surface of a glass substrate 4.

The patterns are constituted by an enamel comprising a second ion.

The substrate 4 is immersed in a bath 5 of molten salt of a third ion having a mobility almost equal to that of the second ion contained in a container 6.

Immersed in the bath 5 is an electrode 7 that is connected to the positive terminal of a generator 8. An electrode 9 attached to the opposite face of the substrate 4, which is opposite the face bearing the patterns 2, 3, 4, is connected to the negative terminal of the generator 8. The container 6 is placed in a furnace (not represented) maintained at a sufficient temperature so that the salt of the third ion 5 is in the molten state.

A voltage is applied between the electrodes 7 and 9 by means of the generator 8. The second ions contained in the patterns 1, 2, 3 and the third ions contained in the bath 5 diffuse simultaneously into the substrate 4.

After the exchange, the substrate 4 is withdrawn from the container 6 and the patterns 1, 2, 3 at the surface of the substrate are removed. The substrate may be subjected to a heat treatment that aims to make the second ions diffuse laterally in the substrate 4.

In FIG. 2, a mask 10 is applied to one face of the substrate 11. The mask 10 is formed from an enamel containing a second ion that consists of Na, K or Li alkali metal ions, or Ca or Sr alkaline-earth metal ions.

The substrate 11 is immersed in a bath 12 of a molten salt of a third ion contained in a container 13. The second and third ions have almost equal mobility.

An electrode 14 is connected to the positive terminal of a generator 15. An electrode 16 placed in a bath 17 of a molten salt is connected to the negative terminal of the generator 15.

The container 13 is placed in a furnace (not represented) to keep the salt of the third ion in the molten state.

A voltage is applied between the electrodes 14 and 16 by means of the generator 15. The second ions contained in the mask 10 and the third ions contained in the bath 12 diffuse simultaneously into the substrate 4.

After the exchange, the substrate 11 is withdrawn from the container 13 and the enamel is removed. The substrate may be subjected to a heat treatment that aims to make the third ions diffuse laterally in the substrate 11.

The substrates 4 and 11 may undergo a cutting step with a view to obtaining the optical elements in individual form. These elements may especially be used in imaging devices.

The examples that follow make it possible to illustrate the invention.

### EXAMPLE 1

This example illustrates the first embodiment described in FIG. 1.

A substrate was formed from a soda-lime-silica glass composition comprising the constituents below, in the following proportions expressed as molar percentages: 71% SiO₂, 13.5% Na₂O, 9.5% CaO and 6% MgO.

Deposited on one face of the substrate (5 cm×5 cm×3.1 mm) was an array of 100 cylindrical patterns (diameter: 600 μm; thickness: 30 μm).

The patterns were formed by screen printing using an enamel composition comprising, in percentages by weight: 75% of silver particles (average size: 1 to 10 μm), 10% of a glass frit and 15% of a mixture of terpineols.

The glass frit had the following composition, expressed in percentages by weight: 36% SiO₂, 30% Bi₂O₃, 24.5% Na₂O, 5.5% CaO, 4% Al₂O₃.

The substrate coated with the screen-printed patterns was subjected to a treatment for firing the enamel at 650° C. for 30 minutes.

The face of the substrate bearing the enamelled patterns was brought into contact with a bath of molten NaNO₃ (320° C.) connected to the positive terminal of a voltage generator. The other face of the substrate was in contact with another bath of molten NaNO₃ (320° C.) connected to the negative terminal of said generator. The ion exchange was carried out for 68 h while applying a potential difference between the terminals of the generator so that the migration rate of the Ag ions in the substrate was equal to 0.07 μm/min.

Measured in the substrate were the depth of exchange of the Ag ions in the glass level with the patterns and the difference in refractive index between the Ag-exchanged glass and the unexchanged glass (Δn):
depth of exchange: 300 μm
Δn=0.03

The enamel was removed using an aqueous solution of nitric acid (68% by weight). The substrate was thinned via the unexchanged face until the thickness was equal to 300 μm, then it was subjected to a heat treatment at 500° C. for 72 h in order to obtain the radial diffusion of the Ag ions in the glass.

FIG. 3 shows the refractive index profile of the optical element before the step of radial diffusion of the Ag ions in the substrate (after exchange) and of the GRIN lens after said step (after exchange and heat treatment).

In the optical element, the refractive index is substantially uniform over the entire depth of exchange of the Ag ions. The GRIN lens has a parabolic shape in the zone between A and B.

### EXAMPLE 2

The conditions from example 1 were followed, modified in that a layer of Ni/Cr having a thickness of 200 nm was deposited by magnetron sputtering over the patterns obtained after the firing of the enamel, and that the substrate did not undergo a step of thinning and of heat treatment for diffusion of the Ag ions.

The measurements were the following:
depth of exchange: 100 μm
Δn=0.07

### EXAMPLE 3

This example illustrates the second embodiment described in FIG. 2.

A substrate was formed from a soda-lime-silica glass composition under the conditions from example 1.

Deposited by screen printing on one face of the substrate (5 cm×5 cm×2.1 mm) was an enamel composition forming a masking layer (thickness: 30 μm) comprising circular openings (diameter: 600 μm). The enamel composition comprised 70% by weight of a glass frit and 30% by weight of castor oil.

The glass frit had the following composition, expressed in weight %: 12% SiO₂, 40% ZnO, 29% Bi₂O₃, 19% Na₂O.

The substrate coated with the screen-printed masking layer was subjected to a treatment for firing the enamel at 680° C. for 6 minutes.

The face of the substrate bearing the enamel mask was brought into contact with a bath of molten AgNO₃ (300° C.) connected to the positive terminal of a voltage generator. The other face of the substrate was brought into contact with an equimolar mixture of NaNO₃ and KNO₃ and was connected to the negative terminal of said generator. The ion exchange was carried out for 6 h while applying a potential difference between the terminals of the generator so that the migration rate of the Ag ions in the substrate was equal to 0.15 μm/min.

Measured in the substrate were the depth of diffusion of the Ag ions in the glass level with the patterns corresponding to the openings in the mask and the difference in refractive index between the Ag-exchanged glass and the unexchanged glass (Δn):
depth of exchange: 50 μm
Δn=0.1

1. A process for the manufacture of a flat optical element, comprising:
a) depositing, at the surface of a glass substrate comprising a first ion, an enamel composition comprising a second ion selected from the group consisting of Ag, Tl, Ba and Cu ions, or precursors thereof, in the form of a pattern or an array of patterns;
b) bringing the substrate to a temperature sufficient to fire the enamel;
c) immersing the substrate into a molten salt that comprises a third ion having a mobility almost equal to that of the second ion;
d) applying an electric field through the immersed substrate so that the second ions originating from the enamel and the third ions originating from the molten salt simultaneously replace the first ions in the substrate;
e) withdrawing the substrate from the molten salt; and
f) removing the enamel.

2. The process as claimed in claim 1, wherein the enamel composition comprises the second ion, at least one glass frit and at least one medium.

3. The process as claimed in claim 2, wherein the glass frit has a melting point greater than or equal to 400° C.

4. The process as claimed in claim 1, wherein the frit is composed of a glass comprising bismuth, boron and zinc.

5. The process as claimed in claim 1, wherein the second ion is present in the enamel composition in the form of an oxide in the glass frit or of a metal.

6. The process as claimed in claim 5, wherein the metal is in the form of particles having an average size that varies from 1 to 10 μm.

7. The process as claimed in claim 1, wherein the amount of second ion represents at least 20%, by weight of the enamel composition.

8. The process as claimed in claim 1, wherein the medium represents 15 to 40% by weight of the enamel composition.

9. The process as claimed in claim 1, wherein the enamel composition is deposited by screen printing, sputtering, inkjet printing or by means of dispensing system(s).

10. The process as claimed in claim 1, wherein the third ion is selected from the group consisting of Na, K, Li Ca and Sr.

11. The process as claimed in claim 1, wherein the salt of the third ion is held at a temperature at least 10° C., above the melting point of the salt.

12. The process as claimed in claim 1, comprising applying a protective layer to the enamel after the enamel is fired.

13. The process as claimed in claim 12, wherein the protective layer is comprises Ni/Cr, Ti, Si or Ag.

14. The process as claimed in claim 12, wherein the layer has a thickness that varies from 100 nm to 1 μm.

15. The process as claimed in claim 1, further comprising reducing the thickness of the substrate after the ion exchange before or after the enamel is removed.

16. The process as claimed in claim 15, wherein the reduction of the thickness is carried out by mechanical treatment, or chemical treatment.

17. The process as claimed in claim 1, further comprising subjecting the substrate to a temperature sufficient to enable a radial diffusion of the third ions.

18. The process as claimed in claim 17, wherein the temperature is between 300 and 700° C.

19. The process as claimed in claim 1, wherein the pattern is circular and is composed of concentric secondary patterns, each concentric secondary pattern being composed of an enamel composition comprising an amount of second ion different from the adjacent secondary pattern.

20. A process for the manufacture of flat optical elements, comprising:
a) masking the surface of a glass substrate that comprises a first ion with an enamel composition comprising a second ion consisting of Na, K or Li alkali metal ions, or Ca or Sr alkaline-earth metal ions;
b) bringing the substrate to a temperature sufficient to fire the enamel;
c) bringing the substrate into contact with a liquid or solid source comprising a third ion consisting of Ag, Tl, Ba or Cu ions;
d) applying an electric field through the substrate so that the second ions originating from the first enamel composition and the third ions originating from the liquid or solid source simultaneously replace the first ions in the substrate; and
e) removing the enamel.

21. The process as claimed in claim 20, wherein the enamel composition comprises a glass frit that comprises said second ion and a medium.

22. The process as claimed in claim 21, wherein the frit is composed of a glass that comprises at least 15% by weight, of said second ion.

23. The process as claimed in claim 22, wherein the frit also comprises at least 10% by weight of zinc and at least 10% by weight of boron.

24. The process as claimed in claim 20, wherein the source comprising the third ion is liquid and is composed of a molten salt of the third ion.

25. The process as claimed in claim 20, wherein the source comprising the third ion is solid and is composed of a deposition of the corresponding metal, of an enamel composition comprising the third ion, at least one glass frit and at least one medium, or of a composition comprising particles of the corresponding metal selected from the group consisting of Ag, Tl, Ba, and Cu and/or particles of a precursor of the third ion.

26. The process as claimed in claim 1, wherein the firing of the enamel is carried out at a temperature above the melting point of the glass frit and below the softening point of the substrate.

27. The process as claimed in claim 1, wherein the electric field is chosen so as to obtain a migration rate of the second and third ions in the substrate that varies from 0.01 to 1 μm/min.

28. The process as claimed in claim 1, wherein an enamel composition comprising a third ion is applied in the peripheral zone of the openings in said mask.

29. The process as claimed in claim 1, wherein the glass substrate comprises glass or glass-ceramic.

30. The process as claimed in claim 29, wherein the glass is a conventional soda-lime-silica or lime-silica glass, a borosilicate glass or an E-type glass that may or may not comprise Ba.

31. The process as claimed in claim 30, wherein the glass has the following composition, expressed as percentages by weight:

| | |
|---|---|
| SiO₂ | 67.0-73.0% |
| Al₂O₃ | 0-3.0% |
| CaO | 7.0-13.0% |
| MgO | 0-6.0% |
| Na₂O | 12.0-16.0% |
| K₂O | 0-4.0%; |
| TiO₂ | 0-0.1%; |
| Total iron (expressed as Fe₂O₃) | 0-0.03% |
| Redox (FeO/total iron) | 0.02-0.4 |
| Sb₂O₃ | 0-0.3%; |
| CeO₂ | 0-1.5%; |
| | and |
| SO₃ | 0-0.8% |

32. The process as claimed in claim 30, wherein the glass has the following composition, expressed as percentages by weight:

| | |
|---|---|
| SiO₂ | 60.0-80.0% |
| Al₂O₃ | 0-8% |
| B₂O₃ | 6.0-16.0%, |
| CaO | 0-2.0% |
| ZnO | 0-1%; |
| BaO | 0-4%; |
| MgO | 0-2.0% |
| Na₂O | 6.0-10.0% |
| K₂O | 0-4.0% |
| TiO₂ | 0-2.0% |
| Total iron (expressed as Fe₂O₃) | 0-0.1% |
| Redox (FeO/total iron) | 0.02-0.6 |
| MnO | 0-0.1%; |
| | and |
| SO₃ | less than 0.2%. |

33. The process as claimed in claim 29, wherein the glass-ceramic has the following composition, expressed as percentages by weight:

| | |
|---|---|
| SiO₂ | 60.0-72.0% |
| Al₂O₃ | 15.0-25.0% |
| CaO | 0-5% |
| MgO | 0-5% |
| ZnO | 0-5% |
| BaO | 0-5% |
| TiO₂ | 0-5% |
| ZrO₂ | 0-5% |
| Li₂O | 2.0-8.0% |
| Na₂O | 0-5% |
| K₂O | 0-5% |
| Total iron (expressed as Fe₂O₃) | 0-0.1% |
| Redox | 0.02-0.6 |
| As₂O₃ | 0-1.0%; |
| ZnS | 0-1.0%; |
| SnO₂ | 0-1.0%; |
| | and |
| impurities (HfO₂, Cr₂O₃ and/or P₂O₃) | <0.5%. |

34. A glass substrate incorporating at least one flat optical element obtained as claimed in the process of claim 1.

35. The substrate as claimed in claim 34, wherein the optical element is a GRIN lens.

36. A glass substrate incorporating at least one flat optical element, in particular a GRIN lens, which has a variation in refractive index (Δn) of at least 0.01 over a depth of at least 50 μm.

37. A glass substrate incorporating at least one flat optical element obtained as claimed in the process of claim 20.

38. The substrate as claimed in claim 20, wherein the optical element is a GRIN lens.
